(19) United States
(12) Patent Application Publication
(10) Pub. No.: US 2026/0045265 A1
(43) Pub. Date: Feb. 12, 2026

(54) EMBEDDED NEURAL CODEC FOR LOW LATENCY SPEECH ENHANCEMENT AND AUTOMATIC SPEECH RECOGNITION IN HEARABLES

(71) Applicant: Cisco Technology, Inc., San Jose, CA (US)

(72) Inventors: Adam Ali SABRA, Union City, CA (US); Kamil Krzysztof WOJCICKI, Kangaroo Point (AU); Samir Mounir HAMZA OUELHA, Suresnes (FR)

(21) Appl. No.: 18/800,222

(22) Filed: Aug. 12, 2024

(51) Int. Cl. G10L 19/028

(52) U.S. Cl. CPC G10L 19/028

(57) ABSTRACT

In one embodiment, an example method for using an embedded neural codec for low latency speech enhancement and automatic speech recognition in hearables includes receiving, at a hearable device, an auditory signal and encoding, at the hearable device, the auditory signal into a compressed vector representation of the auditory signal. The method further includes decoding, at the hearable device using a speech enhancement decoder, the compressed vector representation of the auditory signal into denoised speech outputting, from the hearable device, the denoised speech, and transmitting, from the hearable device, an unprocessed vector representation of the auditory signal to a processing device to cause the processing device to decode, using a speech recognition decoder, the compressed vector representation of the auditory signal.

### TECHNICAL FIELD

The present disclosure relates generally to computer networks, and, more particularly, to an embedded neural codec for low latency speech enhancement and automatic speech recognition in hearables.

### BACKGROUND

Hearable devices, such as hearing aids, ear buds, earphones, headsets, headphones, etc., have become increasingly ubiquitous in the modern world. Hearable devices can come in several forms; for example, they can be provided completely in the ear canal, partially in the ear canal, in the ear, behind the ear, over the ear, with a receiver in the ear canal or a receiver in the ear, or in an “open fit” deployment. Leading to the ubiquity of hearable devices is a rise in purchases of hearable devices both in medical markets (e.g., hearing aids) and in consumer markets (e.g., ear buds, earphones, headsets, headphones, etc.).

On the consumer side, this rise in purchases has been driven by an increase in the desire of consumers to own Bluetooth® ear buds, earphones, headphones, and headsets. On the medical side, this rise in purchases has been driven by over the counter (OTC) inexpensive, low-amplification hearing devices in addition to more traditional prescription-grade hearing aids that must be adjusted (i.e., “fit”) by a hearing professional.

In addition, there has been a rise in “smart” features for both consumer hearable devices and medical hearable devices. In general, these “smart” features can include leveraging Bluetooth® connectivity to allow auditory signals to be received by the hearable device over the air and/or leveraging resources associated with a smartphone (e.g., computing resources, apps, etc.) to provide ostensibly enhanced capabilities. However, reliance on merely providing Bluetooth® capabilities and/or access to apps executed on a smartphone may limit the possibilities of these enhanced capabilities.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 illustrates an example computing system;

FIG. 2 illustrates an example network device/node;

FIG. 3 illustrates an example training flow for a neural codec;

FIG. 4 illustrates an example system including neural codec modules embedded in a hearing device and smartphone device during in-person interactions;

FIG. 5 illustrates an example system including neural codec modules embedded in a hearing device and smartphone device during phone call interactions; and

FIG. 6 illustrates an example procedure for using an embedded neural codec for low latency speech enhancement and automatic speech recognition in hearables.

### DESCRIPTION OF EXAMPLE EMBODIMENTS

### Overview

According to one or more embodiments of the disclosure, an example method for using an embedded neural codec for low latency speech enhancement and automatic speech recognition in hearables includes receiving, at a hearable device, an auditory signal and encoding, at the hearable device, the auditory signal into a compressed vector representation of the auditory signal. The method further includes decoding, at the hearable device using a speech enhancement decoder, the compressed vector representation of the auditory signal into denoised speech outputting, from the hearable device, the denoised speech, and transmitting, from the hearable device, an unprocessed vector representation of the auditory signal to a processing device to cause the processing device to decode, using a speech recognition decoder, the compressed vector representation of the auditory signal.

Other implementations are described below, and this overview is not meant to limit the scope of the present disclosure.

### Description

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, and others. The Internet is an example of a WAN that connects disparate networks throughout the world, providing global communication between nodes on various networks. Other types of networks, such as field area networks (FANs), neighborhood area networks (NANs), personal area networks (PANs), enterprise networks, etc. may also make up the components of any given computer network. In addition, a Mobile Ad-Hoc Network (MANET) is a kind of wireless ad-hoc network, which is generally considered a self-configuring network of mobile routers (and associated hosts) connected by wireless links, the union of which forms an arbitrary topology.

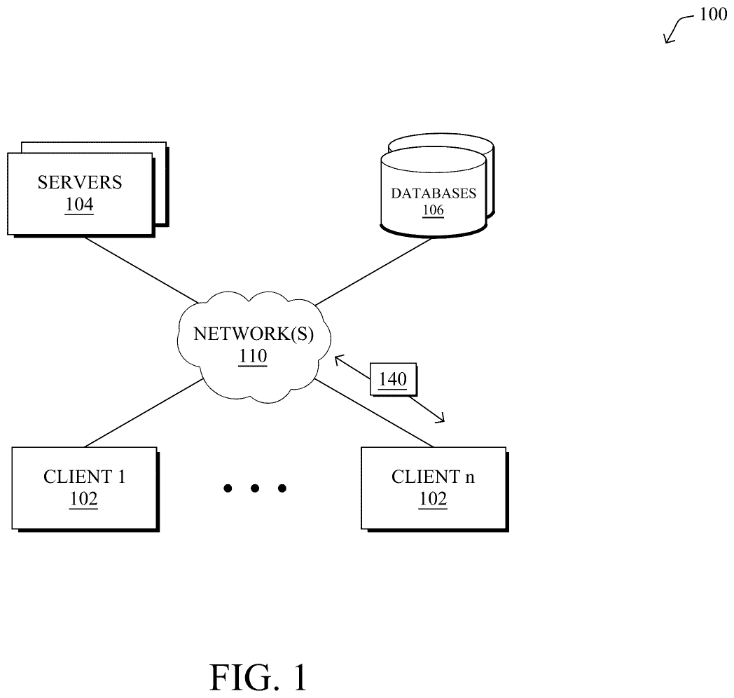

FIG. 1 is a schematic block diagram of an example simplified computing system (e.g., computing system 100) illustratively comprising any number of client devices (e.g., client devices 102, such as a first through nth client device), one or more servers (e.g., servers 104), and one or more databases (e.g., databases 106), where the devices may be in communication with one another via any number of networks (e.g., network(s) 110). The one or more networks (e.g., network(s) 110) may include, as would be appreciated, any number of specialized networking devices such as routers, switches, access points, etc., interconnected via wired and/or wireless connections. For example, the devices shown and/or the intermediary devices in network(s) 110 may communicate wirelessly via links based on WiFi, cellular, infrared, radio, near-field communication, satellite, or the like. Other such connections may use hardwired links, e.g., Ethernet, fiber optic, etc. The nodes/devices typically communicate over the network by exchanging discrete frames or packets of data (packets 140) according to predefined protocols, such as the Transmission Control Protocol/Internet Protocol (TCP/IP) other suitable data structures, protocols, and/or signals. In this context, a protocol consists of a set of rules defining how the nodes interact with each other.

Client devices 102 may include any number of user devices or end point devices configured to interface with the techniques herein. For example, client devices 102 may include, but are not limited to, desktop computers, laptop computers, tablet devices, smart phones, wearable devices (e.g., heads up devices, smart watches, etc.), set-top devices, smart televisions, Internet of Things (IoT) devices, autonomous devices, or any other form of computing device capable of participating with other devices via network(s) 110.

Those skilled in the art will also understand that any number of nodes, devices, links, etc. may be used in computing system 100, and that the view shown herein is for simplicity. As would also be appreciated, computing system 100 may include any number of local networks, data centers, cloud environments, devices/nodes, servers, etc. Also, those skilled in the art will further understand that while the network is shown in a certain orientation, the computing system 100 is merely an example illustration that is not meant to limit the disclosure.

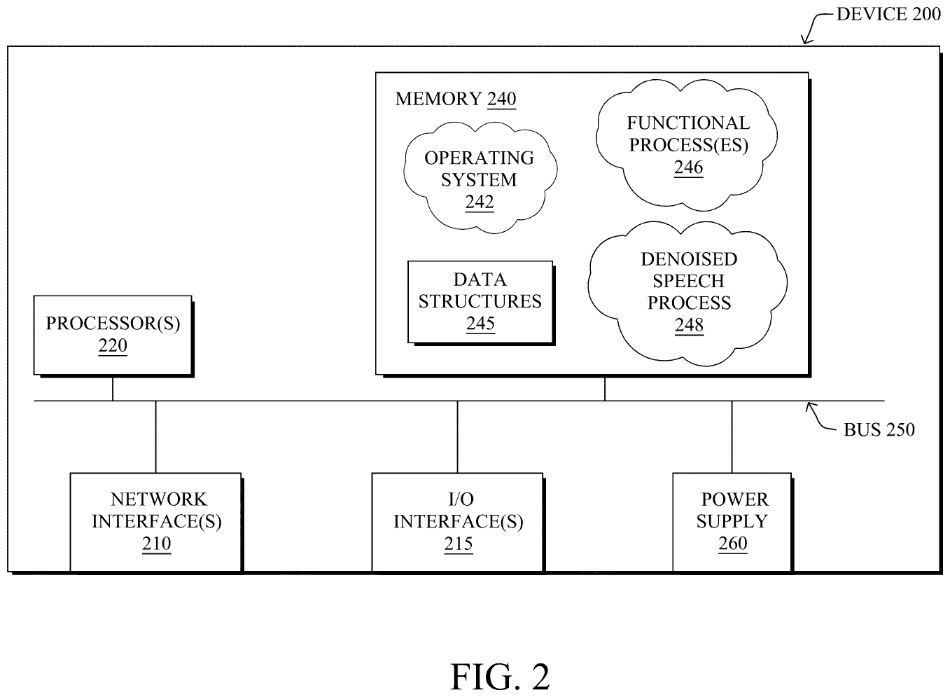

FIG. 2 is a schematic block diagram of an example node/device 200 (e.g., an apparatus) that may be used with one or more implementations described herein, e.g., as any of the nodes or devices shown in FIG. 1 above or described in further detail below. The device 200 may comprise one or more of the network interfaces 210 (e.g., wired, wireless, etc.), input/output interfaces (I/O interfaces 215, inclusive of any associated peripheral devices such as displays, keyboards, cameras, microphones, speakers, etc.), at least one processor (e.g., processor(s) 220), and a memory 240 interconnected by a system bus 250, as well as a power supply 260 (e.g., battery, plug-in, etc.).

The network interfaces 210 include the mechanical, electrical, and signaling circuitry for communicating data over physical links coupled to the computing system 100. The network interfaces may be configured to transmit and/or receive data using a variety of different communication protocols. Notably, a physical network interface (e.g., network interfaces 210) may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the implementations described herein. The processor(s) 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software processors and/or services may comprise one or more functional processes 246, and on certain devices, a denoised speech process (process 248), as described herein, each of which may alternatively be located within individual network interfaces.

Notably, one or more functional processes 246, when executed by processor(s) 220, cause each device 200 to perform the various functions corresponding to the particular device's purpose and general configuration. For example, a router would be configured to operate as a router, a server would be configured to operate as a server, an access point (or gateway) would be configured to operate as an access point (or gateway), a client device would be configured to operate as a client device, and so on.

In various implementations, as detailed further below, one or more functional processes 246 and/or denoised speech process (process 248) may include computer executable instructions that, when executed by processor(s) 220, cause device 200 to perform the techniques described herein. To do so, in some implementations, one or more functional processes 246 and/or process 248 may utilize machine learning. In general, machine learning is concerned with the design and the development of techniques that take as input empirical data (such as network statistics and performance indicators) and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a, b, c such that the number of misclassified points is minimal. After this optimization phase (or learning phase), model M can be used very easily to classify new data points. Often, M is a statistical model, and the cost function is inversely proportional to the likelihood of M, given the input data.

In various implementations, one or more functional processes 246 and/or process 248 may employ one or more supervised, unsupervised, or semi-supervised machine learning models. Generally, supervised learning entails the use of a training set of data, as noted above, that is used to train the model to apply labels to the input data. For example, the training data may include sample network observations that do, or do not, violate a given network health status rule and are labeled as such. On the other end of the spectrum are unsupervised techniques that do not require a training set of labels. Notably, while a supervised learning model may look for previously seen patterns that have been labeled as such, an unsupervised model may instead look to whether there are sudden changes in the behavior. Semi-supervised learning models take a middle ground approach that uses a greatly reduced set of labeled training data.

Example machine learning techniques that one or more functional processes 246 and/or process 248 can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), generative adversarial networks (GANs), long short-term memory (LSTM), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for timeseries), random forest classification, or the like.

In further implementations, one or more functional processes 246 and/or process 248 may also include one or more generative artificial intelligence/machine learning models. In contrast to discriminative models that simply seek to perform pattern matching for purposes such as anomaly detection, classification, or the like, generative approaches instead seek to generate new content or other data (e.g., audio, video/images, text, etc.), based on an existing body of training data. For instance, in the context of network assurance, one or more functional processes 246 and/or process 248 may use a generative model to generate synthetic network traffic based on existing user traffic to test how the network reacts. Example generative approaches can include, but are not limited to, generative adversarial networks (GANs), large language models (LLMs), other transformer models, and the like. In some instances, one or more functional processes 246 and/or process 248 may be executed to intelligently route LLM workloads across executing nodes (e.g., communicatively connected GPUs clustered into domains).

The performance of a machine learning model can be evaluated in a number of ways based on the number of true positives, false positives, true negatives, and/or false negatives of the model in the case of evaluation of classification models, Mean Square Error (MSE), or domain specific models, such as PESQ, POLQA, and/or NISQA in the case of evaluation of regression models, e.g., for speech quality evaluation, and/or Word Error Rate (WER) for automatic speech recognition (ASR) evaluation, among others. For example, the false positives of the model may refer to the number of times the model incorrectly predicted whether a network health status rule was violated. Conversely, the false negatives of the model may refer to the number of times the model predicted that a health status rule was not violated when, in fact, the rule was violated. True negatives and positives may refer to the number of times the model correctly predicted whether a rule was violated or not violated, respectively. Related to these measurements are the concepts of recall and precision. Generally, recall refers to the ratio of true positives to the sum of true positives and false negatives, which quantifies the sensitivity of the model. Similarly, precision refers to the ratio of true positives to the sum of true and false positives. Further, as will be appreciated, PESQ uses a powerful technique, based on PAMS, to identify and account for delay changes using auditory transform techniques. The reference and degraded signals are passed through an auditory transform that mimics key properties of human hearing. This transform removes those parts of the signal that are inaudible to the listener. Moreover, as will be appreciated, WER is a widely used measurement of the performance of speech recognition and machine translation systems. It divides the total number of errors in the auto-generated text by the total number of words in the human-generated (reference) text.

It will be apparent to those skilled in the art that other processor and memory types, including various computer-readable media, may be used to store and execute program instructions pertaining to the techniques described herein. Also, while the description illustrates various processes, it is expressly contemplated that various processes may be implemented as modules configured to operate in accordance with the techniques herein (e.g., according to the functionality of a similar process). Further, while processes may be shown and/or described separately, those skilled in the art will appreciate that processes may be routines or modules within other processes.

### Embedded Neural Codec for Low Latency Speech Enhancement and Automatic Speech Recognition in Hearables

As noted above, hearable devices, such as hearing aids, ear buds, earphones, headsets, headphones, etc., have become increasingly ubiquitous in the modern world. Hearable devices can come in several forms, for example, they can be provided completely in the ear canal, partially in the ear canal, in the ear, behind the ear, over the ear, with a receiver in the ear canal or a receiver in the ear, or in an “open fit” deployment. Leading to the ubiquity of hearable devices is a rise in purchases of hearable devices both in medical markets (e.g., hearing aids) and in consumer markets (e.g., ear buds, earphones, headsets, headphones, etc.).

On the consumer side, this rise in purchases has been driven by an increase in the desire of consumers to own Bluetooth® ear buds, earphones, headphones, and headsets. On the medical side, this rise in purchases has been driven by over the counter (OTC) inexpensive, low-amplification hearing devices in addition to more traditional prescription-grade hearing aids that must be adjusted (i.e., “fit”) by a hearing professional.

In addition, as also mentioned above, there has been a rise in “smart” features for both consumer hearable devices and medical hearable devices. In general, these “smart” features boil down to leveraging Bluetooth® connectivity to allow auditory signals to be received by the hearable device over the air and/or leveraging resources associated with a smartphone (e.g., computing resources, apps, etc.) to provide ostensibly enhanced capabilities. However, reliance on merely providing Bluetooth® capabilities and/or access to apps executed on a smartphone may lead to scenarios in which these enhanced capabilities are limited in scope.

That is, these “smart” features generally merely imply Bluetooth® connectivity and leveraging the smartphone resources for enhanced capabilities. Specifically, previous approaches do not implement an embedded neural codec within the hearable device itself. In contrast, implementations disclosed herein provide for an embedded neural codec within a hearable hardware device, as well as embedding modules of the neural codec within a smartphone application such that the suite of features for the hearing devices are enhanced for both in-person interactions and phone calls.

As discussed in more detail herein, for hearing aids, the systems of the present disclosure can utilize Bluetooth® (or a proprietary communication via a separate relay device, whether near field communication (NFC) or other communication protocol) to send audio to a smartphone, leverage the smartphone's resources (e.g., for denoising), and send the audio back to the hearing aids.

For consumer use cases, denoising can generally be done locally on the device using traditional noise reduction methods or more recent data driven approaches, the latter of which are discussed in more detail herein. For example, a neural codec can be used for local speech enhancement on the device itself (in some cases irrespective if the neural codec is actually being used for transmission of audio or other data to other devices).

As discussed in more detail herein, implementations of the present disclosure can utilize smartphone resources for audio enhancement, among other things, during phone calls in order to reduce the compute burden and/or battery drain on the hearable device itself. Due to latency requirements between different scenarios, for example, latency requirements are generally less restrictive for call audio than during in-person situations, several approaches in which the neural codec can be used for both enhancement and transcription are discussed herein. It is noted that providing transcription can offer additional benefits to the user by allowing the user to have a text transcription of, for example, a conversation.

The techniques herein, in particular, provide for a low-latency neural network-based codec that is integrated in hearable devices, such as Bluetooth® enabled devices, for multi-use purposes that can include real time speech enhancement and/or automatic speech recognition, as well as transcription of the speech enhanced and/or recognized by the system. For example, by integrating a neural codec and processing circuitry associated therewith into the hearable device, as described herein, latency can be reduced while providing denoised speech to a user of the hearable device, which can enhance the experience of the user of the hearable device without sacrificing accuracy and/or quality of the auditory reproduction enjoyed by said user.

Specifically, according to one or more embodiments of the disclosure as described in detail below, an example method for using an embedded neural codec for low latency speech enhancement and automatic speech recognition in hearables includes receiving, at a hearable device, an auditory signal and encoding, at the hearable device, the auditory signal into a compressed vector representation of the auditory signal. The method further includes decoding, at the hearable device using a speech enhancement decoder, the compressed vector representation of the auditory signal into denoised speech outputting, from the hearable device, the denoised speech, and transmitting, from the hearable device, an unprocessed vector representation of the auditory signal to a processing device to cause the processing device to decode, using a speech recognition decoder, the compressed vector representation of the auditory signal.

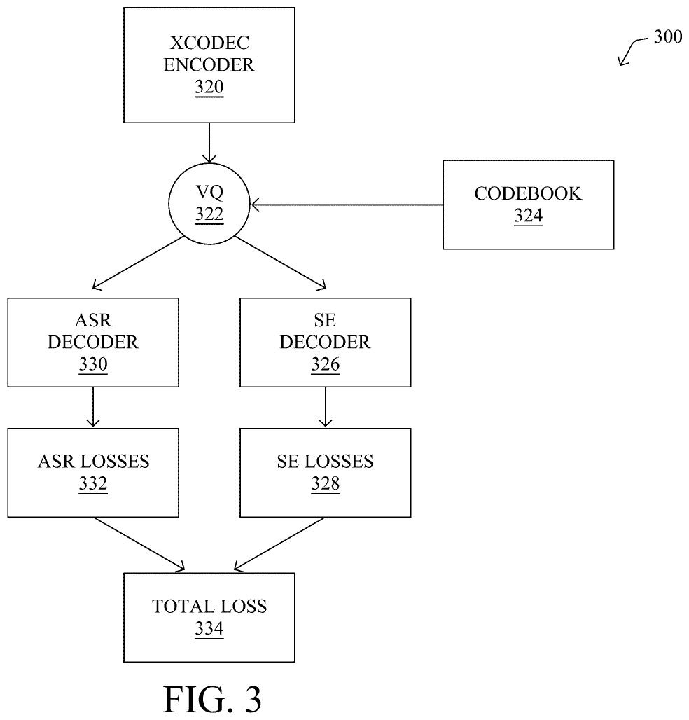

Operationally, FIG. 3 illustrates an example training flow for a neural codec 300. As will be appreciated, the neural codec 300 can be a language model that operates to provide zero-shot text to speech (TTS) synthesis (or also “speech synthesis”). A neural codec 300 can be used in conjunction with a hearable device to encode and/or decode auditory signals to provide speech synthesis in accordance with the disclosure. In some implementations, the low-latency speech enhancement neural codec disclosed herein can be embedded and can be run (executed) in its entirety (both encoder and decoder) within the hearable device itself. In FIG. 3, the training process of the proposed network is described.

In some implementations, the modularity of neural codecs can be leveraged such that multiple solutions can be delivered in a low-latency fashion. The first such solution is in the context of speech enhancement (SE) and the second such solution is in the context of automatic speech recognition (ASR.) The first system proposal is outlined below, in which a hearing aid workflow when the hearing aid is being used for in person interactions is discussed.

As shown in FIG. 3, the example training flow can begin at operation 320 where a generalized encoder is used to transform an auditory signal (e.g., speech) captured by a microphone (or microphones) of the hearable device into an embedded (e.g., compressed) representation of the auditory signal. This embedded representation of the auditory signal is then fed into a vector quantizer (VQ) at operation 322 and, at operation 324, a codebook associated with the VQ.

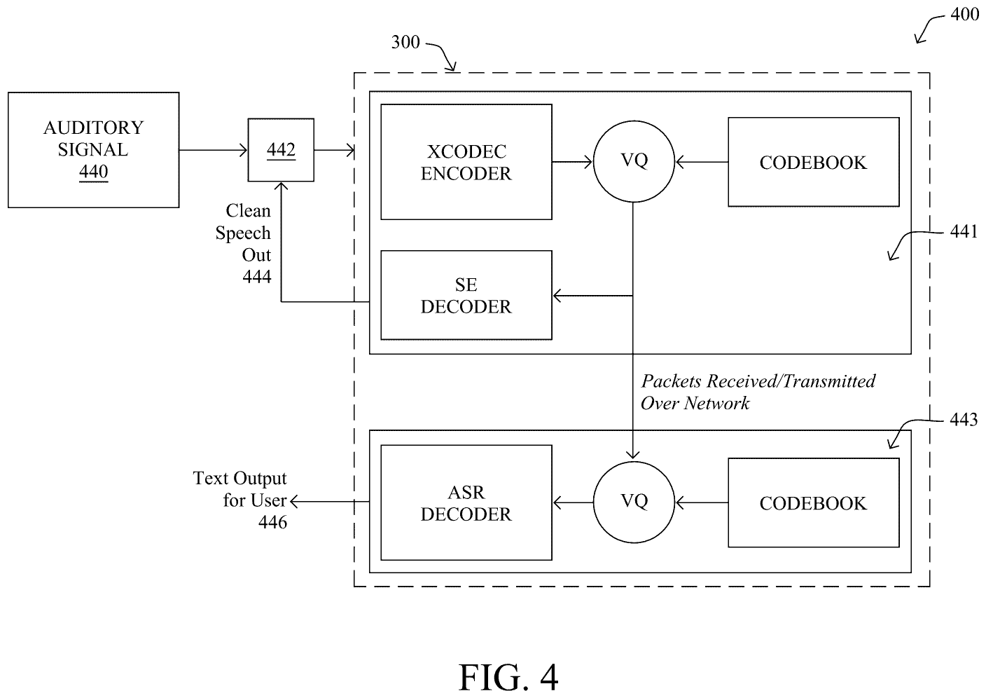

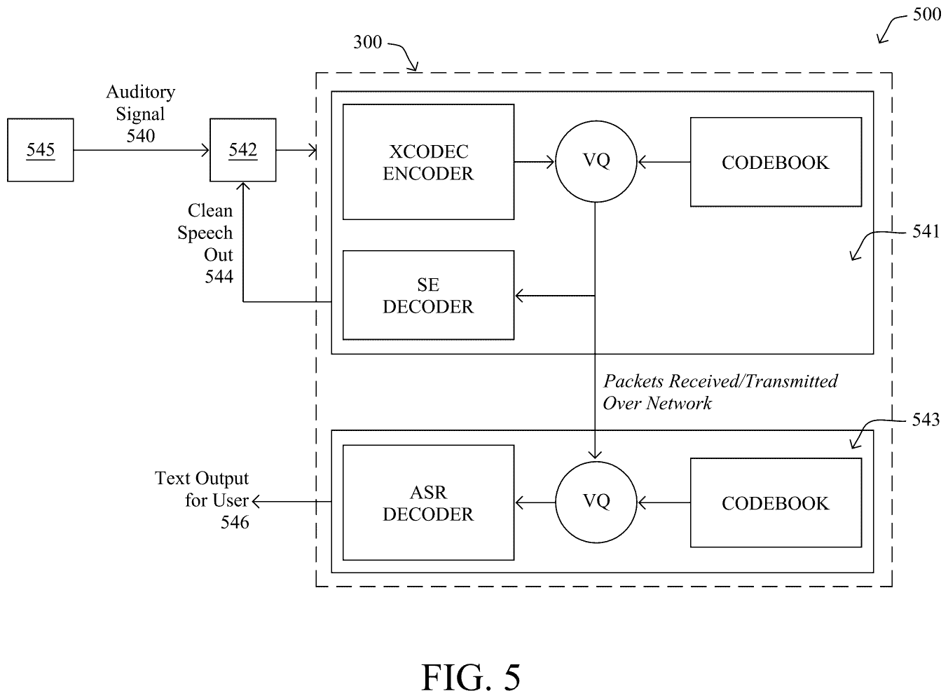

The core objective of the encoder, VQ, and codebook, is to drastically reduce bitrate while preserving perceptual audio quality. This can allow for the already limited hearing device hardware to efficiently transmit packets to a smartphone application (referred to herein for brevity as an “app”) in a phone call use case discussed herein in connection with FIG. 4 and/or FIG. 5. As shown in FIG. 3, both the encoder and VQ serve as the generalized portions of the system, and two different decoders are trained together: one for automatic speech recognition (ASR), shown at operation 330 and another one for speech enhancement (SE), shown at operation 326.

For each of these training tasks, defined specific loss functions can be assigned and utilized. For example, at operation 328 (for SE), a distance-based loss in the short-time Fourier transform (STFT) domain at different resolutions can be used. In addition to, or in the alternative, adversarial losses that more relate to human perception can also be used. At operation 332 (for ASR), a Recurrent Neural Network Transducer (RNN-T) and/or connectionist temporal classification (CTC) techniques can be used. Finally, at operation 334, the losses calculated at operation 328 and at operation 332 can be summed together (i.e., “total loss”). In order to perform this summation, a dynamic weight to balance the ASR and SE decoder losses during the training can be introduced.

In some implementations, at least a portion of the training tasks or processes mentioned above can also use the dynamic weight(s) associated with the loss functions to provide weight updates of the individual neural network subcomponents (e.g., the encoder(s) and/or decoder(s)). In addition, codebook entries may be updated based on the weight updates that are determined during training tasks or processes mentioned above to further enhance performance of the system described herein.

In some implementations, the neural network (e.g., the neural codec 300) associated with the example training flow can be in a low-complexity fashion (e.g., at approximately fifty Mega Multiply-Accumulate operations per second (MMAC/s)) and can be further pruned and/or quantized for improved inference performance. It will, however, be appreciated that other complexities, operations per second, etc. are contemplated without departing from the scope of the disclosure.

FIG. 4 illustrates an example system 400 including neural codec modules embedded in a hearing device and smartphone device during in-person interactions. As illustrated in FIG. 4, a first neural codec module 441 and a second neural codec module 443 are utilized to perform a portion of the operations described herein. The non-limiting example illustrated in FIG. 4 shows an in-person conversation where a speaker is talking to a user of a hearable device. It is noted that in-person conversational situations may require response latencies less than eight milliseconds (“<8 ms”) to avoid detrimental effects of mixing of the direct and delayed-and-amplified audio paths and, accordingly, implementations of the present disclosure can operate within these latency tolerances or lower. Further, it will be appreciated that implementations are not limited to this particular example.

It is noted that, when taken together, the first neural codec module 441 and the second neural codec module 443 form the neural codec 300 of FIG. 3. That is, the encoder, VQ, codebook, SE decoder and ASR decoder of FIG. 4 can be analogous to the respective components with the same names in FIG. 3. In some implementations, the first neural codec module 441 can be embedded within a hearable device (e.g., the hearable device 442) and the second neural codec module 443 can be embedded in a user device, such as a smartphone, tablet, phablet, laptop, smart watch, and/or smart glasses, etc. (not specifically illustrated so as to not obfuscate the drawing layout).

As shown in FIG. 4, an auditory signal 440 is input to and therefore received by a hearable device 442. A variety of hearable devices are shown in FIG. 4, although it will be appreciated that these various hearable devices are shown merely for illustrative purposes, and other types of hearable devices are contemplated within the scope of the disclosure.

The auditory signal 440 is then processed by the first neural codec module 441. As mentioned above, the first neural codec module 441 can be “embedded” in the hearable device 442. As used herein, the term “embedded” can generally refer to a condition in which hardware and/or software configured to, in concert, perform a certain action or set of actions are physically within the component to which they are “embedded. ” As an example, the first neural codec module 441 module being “embedded” in the hearable device 442 refers to a condition in which the hardware that executes software (e.g., computer code, machine code, machine-readable instructions, etc.) in conjunction with the operations described herein is physically integrated within the hearable device 442.

Subsequent to processing by the first neural codec module 441, clean (e.g., denoised, filtered, enhanced, etc.) speech can be provided to the hearable device 442 as shown at operation 444 where clean speech is output to the hearable device. In tandem with, or subsequent to processing of the auditory signal 440 by the first neural codec module 441, the auditory signal 440 can also be processed by the second neural codec module 443.

For example, as shown in FIG. 4, the auditory signal 440 can be transferred over a network to the second neural codec module 443 for processing. Once processed by the second neural codec module 443, a text output can be generated by the second neural codec module 443 as shown at operation 446. In some implementations, the text output can be presented for display on user device, such as a user interface, smartphone screen, computer screen, etc.

In the example of FIG. 4, the output of the vector quantizer (VQ) serves two purposes:
First, the sequence of quantized embeddings is fed into a decoder trained to denoise speech (e.g., using the first neural codec module 441) which will output at a reduced bitrate and then to provide enhanced clean speech back into the hearable device; and
Second, the indices of codebook vectors can then be transmitted over the network into a smartphone app (e.g., an app that is running the second neural codec module 443) designed to work with the corresponding hearable device.

In some implementations, a smartphone app can receive a sequence of codeword indices and convert the same into a sequence of codewords. A decoder associated with the smartphone app (e.g., the ASR decoder) and/or a decoder trained for decoding the codeword sequence into text can be utilized to provide the text output shown as shown at operation 446. Because ASR systems are generally trained on “noisy” speech, implementations of the present disclosure can allow for utilization of the vector quantized representation of the embeddings of the input speech processed by the ASR decoder without necessarily invoking SE cleaning.

As a result, the smartphone app may then be able to output the transcribed text of what is spoken as shown in FIG. 4. Accordingly, in some implementations, the output of the hearable device in concert with the smartphone app combination can provide both enhanced speech and the corresponding text of said speech.

FIG. 5 illustrates an example system 500 including neural codec modules embedded in a hearing device and smartphone device during phone call interactions. In the example implementation of FIG. 5, the same general workflow as shown in FIG. 4 is followed. However, as opposed to having speech in a potentially noisy environment coming in at a lower latency (<8 ms) in the in-person conversation example of FIG. 4, in the example of FIG. 5, a phone call (or similar telecommunication) can be coming in at considerably higher latency (e.g., >8 ms) than in the in-person conversation example of FIG. 4.

As shown in FIG. 4, a first neural codec module 541 and a second neural codec module 543 are utilized to perform a portion of the operations described herein. The non-limiting example illustrated in FIG. 5 shows conversation where an auditory signal is received at the hearable device from a phone or similar device as opposed to an in-person communication.

As shown in FIG. 5, a first neural codec module 541 and a second neural codec module 543 are utilized to perform a portion of the operations described herein. It is noted that, when taken together, the first neural codec module 541 and the second neural codec module 543 form the neural codec 300 of FIG. 3. That is, the encoder, VQ, codebook, SE decoder and ASR decoder of FIG. 5 can be analogous to the respective components with the same names in FIG. 3 and/or FIG. 4. It is further noted that the first neural codec module 541 and the second neural codec module 543 can be analogous to the first neural codec module 441 and the second neural codec module 443 of FIG. 4.

That is, the encoder, VQ, codebook, SE decoder, and ASR decoder of FIG. 5 can be analogous to the respective components with the same names in FIG. 3 and/or FIG. 4. In some implementations, the first neural codec module 541 can be embedded within a hearable device (e.g., the hearable device 542) and the second neural codec module 543 can be embedded in a user device, such as a smartphone, tablet, phablet, laptop, smart watch, and/or smart glasses, etc. (not specifically illustrated so as to not obfuscate the drawing layout).

As shown in FIG. 5, an auditory signal 540 is received from a phone 545 (e.g., a smartphone, telephone, web-based communication system, etc.) and is input to and therefore received by a hearable device 542. In some implementations, the auditory signal 540 is provided by the phone 545 via Bluetooth® or other near field communication protocol, although implementations are not so limited.

The auditory signal 540 is then processed by the first neural codec module 541. Subsequent to processing by the first neural codec module 541, clean (e.g., denoised, filtered, enhanced, etc.) speech can be provided to the hearable device 542 as shown at operation 544 where clean speech is output to the hearable device. In tandem with, or subsequent to processing of the auditory signal 540 by the first neural codec module 541, the auditory signal 540 can also be processed by the second neural codec module 543.

For example, as shown in FIG. 5, the auditory signal 540 can be transferred over a network to the second neural codec module 543 for processing. Once processed by the second neural codec module 543, a text output can be generated by the second neural codec module 543 as shown at operation 546. In some implementations, the text output can be presented for display on user device, such as a user interface, smartphone screen, computer screen, etc.

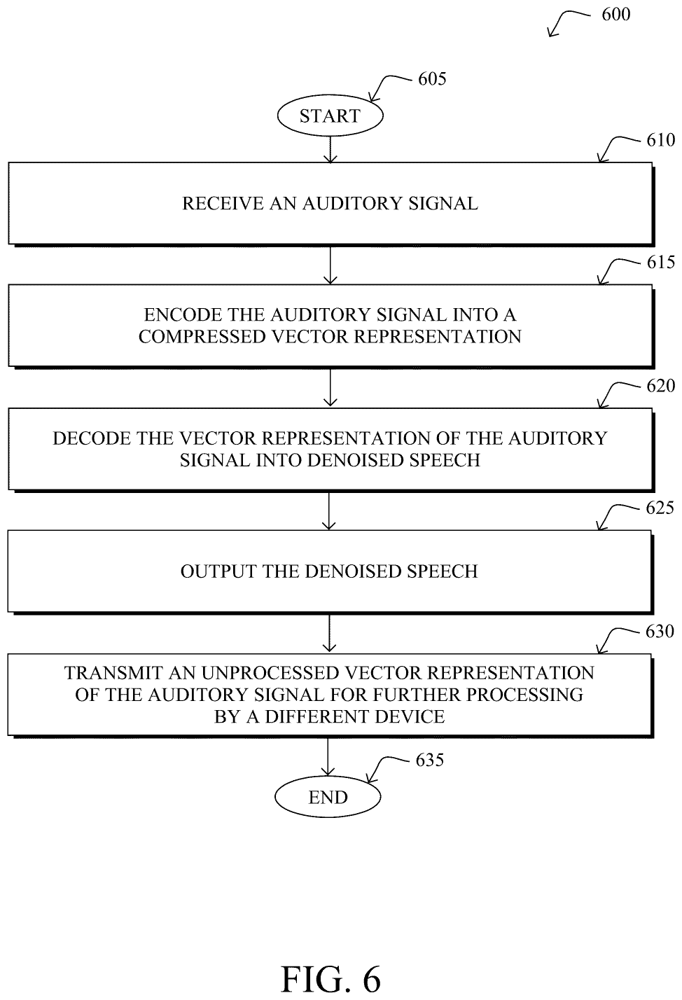

In closing, FIG. 6 illustrates an example procedure for embedded neural codec for low latency speech enhancement and automatic speech recognition in hearables. For example, a non-generic, specifically configured device (e.g., device 200, an apparatus, such as a hearable device) may perform procedure 600 by executing stored instructions (e.g., process 248). The procedure 600 may start at step 605, and continues to step 610, where, as described in greater detail above, a hearable device receives an auditory signal. As discussed above, in some implementations, the hearable device can be a hearing aid. Implementations are not so limited, however, and in some implementations, the hearable device can be a device selected from a group consisting of: a headset, a loudspeaker, an in-wall speaker, a ceiling speaker, a soundbar, a computer speaker, or a subwoofer.

Procedure 600 may continue to step 615 where, as described in greater detail above, the hearable device encodes the auditory signal into a compressed vector representation of the auditory signal. In some implementations, the auditory signal can comprise words spoken (e.g., by a person) and received as audio waves into a microphone of the hearable device or other associated device. Implementations are not so limited, however, and in some implementations, the auditory signal can be spoken words as received via Bluetooth® communication.

Procedure 600 may continue to step 620 where, as described in greater detail above, the hearable device decodes, using a speech enhancement decoder, the vector representation of the auditory signal into denoised speech.

Procedure 600 may continue to step 625 where, as described in greater detail above, the hearable device outputs the denoised speech. In some implementations, the procedure 600 can further include displaying, on a screen of a user device, text corresponding to the denoised speech. Implementations are not so limited, however, and in some implementations, the procedure can further include providing, via a wearable device, text and/or speech output corresponding to the denoised speech. Non-limiting examples of wearable devices can include a smart watch, an augmented reality device, and/or a smart glasses device, among others.

Procedure 600 may continue to step 630 where, as described in greater detail above, the hearable device transmits an unprocessed vector representation of the auditory signal to a processing device to cause the processing device to decode, using a speech recognition decoder, the compressed vector representation of the auditory signal. In some implementations, the processing device can be on a different device (e.g., a smartphone) as opposed to within the hearable device.

In some implementations, at least one of the speech enhancement decoder and the speech recognition decoder is trained to perform the decoding using a neural network.

As discussed above, the procedure 600 can further include determining a first loss function for the speech enhancement decoder and a second loss function for the speech recognition decoder and computing a total loss for the speech enhancement decoder and the speech recognition decoder by performing dynamic weight balancing using the first loss function and the second loss function. In some implementations, the procedure 600 further includes updating weights associated with models used to train speech enhancement decoder and the speech recognition decoder to minimize the total loss.

Procedure 600 may end at step 635.

It should be noted that while certain steps within the procedures above may be optional as described above, the steps shown in the procedures above are merely examples for illustration, and certain other steps may be included or excluded as desired. Further, while a particular order of the steps is shown, this ordering is merely illustrative, and any suitable arrangement of the steps may be utilized without departing from the scope of the embodiments herein. Moreover, while procedures may have been described separately, certain steps from each procedure may be incorporated into each other procedure, and the procedures are not meant to be mutually exclusive.

In some implementations, an illustrative apparatus herein may comprise: one or more network interfaces to communicate with a network; a processor coupled to the one or more network interfaces and configured to execute one or more processes; and a memory configured to store a process that is executable by the processor, the process comprising: receiving, at a hearable device, an auditory signal; encoding, at the hearable device, the auditory signal into a compressed vector representation of the auditory signal; decoding, at the hearable device using a speech enhancement decoder, the vector representation of the auditory signal into denoised speech; outputting, from the hearable device, the denoised speech; and transmitting, from the hearable device, an unprocessed vector representation of the auditory signal to a processing device to cause the processing device to decode, using a speech recognition decoder, the compressed vector representation of the auditory signal.

In still other implementations, a tangible, non-transitory, computer-readable medium storing program instructions that cause a device to execute a process comprising: receiving, at a hearable device, an auditory signal; encoding, at the hearable device, the auditory signal into a compressed vector representation of the auditory signal; decoding, at the hearable device using a speech enhancement decoder, the vector representation of the auditory signal into denoised speech; outputting, from the hearable device, the denoised speech; and transmitting, from the hearable device, an unprocessed vector representation of the auditory signal to a processing device to cause the processing device to decode, using a speech recognition decoder, the compressed vector representation of the auditory signal.

The techniques described herein, therefore, provide for an embedded neural codec for low latency speech enhancement and automatic speech recognition in hearables. In some implementations, the low-latency neural network-based codec can be integrated in a hearable device for multi-use purpose uses including real time speech enhancement and automatic speech recognition, as well as transcription of the speech enhanced and/or recognized by the system.

By integrating the neural codec and processing circuitry associated therewith into the hearable device, latency can be reduced while providing denoised speech to a user of the hearable device, which can enhance the experience of the user of the hearable device without sacrificing accuracy and/or quality of the auditory reproduction enjoyed by said user.

Illustratively, the techniques described herein may be performed by hardware, software, and/or firmware, (e.g., an “apparatus”) such as in accordance with the denoised speech process, process 248, e.g., a “method”), which may include computer-executable instructions executed by the processor(s) 220 to perform functions relating to the techniques described herein, e.g., in conjunction with corresponding processes of other devices in the computer network as described herein (e.g., on peripherals, accessories, computing devices, other user devices, servers, etc.). In addition, the components herein may be implemented on a singular device or in a distributed manner, in which case the combination of executing devices can be viewed as their own singular “device” for purposes of executing the process (e.g., process 248).

While there have been shown and described illustrative implementations above, it is to be understood that various other adaptations and modifications may be made within the scope of the implementations herein. For example, while certain implementations are described herein with respect to certain types of networks in particular, the techniques are not limited as such and may be used with any computer network, generally, in other implementations. Moreover, while specific technologies, protocols, architectures, schemes, workloads, languages, etc., and associated devices have been shown, other suitable alternatives may be implemented in accordance with the techniques described above. In addition, while certain devices are shown, and with certain functionality being performed on certain devices, other suitable devices and process locations may be used, accordingly. Also, while certain embodiments are described herein with respect to using certain models for particular purposes, the models are not limited as such and may be used for other functions, in other embodiments.

Moreover, while the present disclosure contains many other specifics, these should not be construed as limitations on the scope of any implementation or of what may be claimed, but rather as descriptions of features that may be specific to particular implementations. Certain features that are described in this document in the context of separate implementations can also be implemented in combination in a single implementation. Conversely, various features that are described in the context of a single implementation can also be implemented in multiple implementations separately or in any suitable sub-combination. Further, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the implementations described in the present disclosure should not be understood as requiring such separation in all implementations.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true intent and scope of the implementations herein.

What is claimed is:

1. A method, comprising:
receiving, at a hearable device, an auditory signal;
encoding, at the hearable device, the auditory signal into a compressed vector representation of the auditory signal;
decoding, at the hearable device using a speech enhancement decoder, the compressed vector representation of the auditory signal into denoised speech;
outputting, from the hearable device, the denoised speech; and
transmitting, from the hearable device, an unprocessed vector representation of the auditory signal to a processing device to cause the processing device to decode, using a speech recognition decoder, the compressed vector representation of the auditory signal.

2. The method of claim 1, wherein the hearable device comprises a hearing aid.

3. The method of claim 1, wherein the hearable device is selected from a group consisting of: a headset, a loudspeaker, an in-wall speaker, a ceiling speaker, a soundbar, a computer speaker, or a subwoofer.

4. The method of claim 1, wherein at least one of the speech enhancement decoder and the speech recognition decoder is trained to perform decoding using a neural network.

5. The method of claim 1, further comprising:
determining a first loss function for the speech enhancement decoder and a second loss function for the speech recognition decoder;
computing a total loss for the speech enhancement decoder and the speech recognition decoder by performing dynamic weight balancing using the first loss function and the second loss function; and
updating weights associated with models used to train speech enhancement decoder and the speech recognition decoder to minimize the total loss.

6. The method of claim 1, wherein the auditory signal comprises words spoken by a person.

7. The method of claim 1, wherein the auditory signal is received via a near field communication protocol.

8. The method of claim 1, further comprising:
displaying, on a screen of a user device, text corresponding to the denoised speech.

9. The method of claim 8, wherein the user device is a wearable device.

10. The method of claim 9, wherein the wearable device is selected from a group consisting of: a smart watch, an augmented reality device, and a smart glasses device.

11. An apparatus, comprising:
one or more network interfaces to communicate with a network;
a processor coupled to the one or more network interfaces and configured to execute one or more processes; and
a memory configured to store a process that is executable by the processor, the process comprising:
receiving, at a hearable device, an auditory signal;
encoding, at the hearable device, the auditory signal into a compressed vector representation of the auditory signal;
decoding, at the hearable device using a speech enhancement decoder, the compressed vector representation of the auditory signal into denoised speech;
outputting, from the hearable device, the denoised speech; and
transmitting, from the hearable device, an unprocessed vector representation of the auditory signal to a processing device to cause the processing device to decode, using a speech recognition decoder, the compressed vector representation of the auditory signal.

12. The apparatus of claim 11, wherein the hearable device comprises a hearing aid.

13. The apparatus of claim 11, wherein the hearable device is selected from a group consisting of: a headset, a loudspeaker, an in-wall speaker, a ceiling speaker, a soundbar, a computer speaker, or a subwoofer.

14. The apparatus of claim 11, wherein at least one of the speech enhancement decoder and the speech recognition decoder is trained to perform decoding using a neural network.

15. The apparatus of claim 11, wherein the process further comprises:
determining a first loss function for the speech enhancement decoder and a second loss function for the speech recognition decoder;
computing a total loss for the speech enhancement decoder and the speech recognition decoder by performing dynamic weight balancing using the first loss function and the second loss function; and
updating weights associated with models used to train speech enhancement decoder and the speech recognition decoder to minimize the total loss.

16. The apparatus of claim 11, wherein the auditory signal comprises words spoken by a person.

17. The apparatus of claim 11, wherein the auditory signal is received via a near field communication protocol.

18. The apparatus of claim 11, further comprising:
displaying, on a screen of a user device, text corresponding to the denoised speech.

19. The apparatus of claim 18, wherein the user device is a wearable device.

20. A tangible, non-transitory, computer-readable medium storing program instructions that cause a device to execute a process comprising:
receiving, at a hearable device, an auditory signal;
encoding, at the hearable device, the auditory signal into a compressed vector representation of the auditory signal;
decoding, at the hearable device using a speech enhancement decoder, the compressed vector representation of the auditory signal into denoised speech;
outputting, from the hearable device, the denoised speech; and
transmitting, from the hearable device, an unprocessed vector representation of the auditory signal to a processing device to cause the processing device to decode, using a speech recognition decoder, the compressed vector representation of the auditory signal.
